(19) United States
(12) Patent Application Publication
(10) Pub. No.: US 2017/0287305 A1
(43) Pub. Date: Oct. 5, 2017

(54) ADAPTIVE CLIENT DEVICE NOTIFICATION SYSTEM AND METHODS

(71) Applicant: Fawzan Alqudairi, Riyadh (SA)

(72) Inventor: Fawzan Alqudairi, Riyadh (SA)

(21) Appl. No.: 15/088,617

(22) Filed: Apr. 1, 2016

(51) Int. Cl. G08B 21/04

(52) U.S. Cl. CPC G08B 21/0453

(57) ABSTRACT

An adaptive client device notification system and methods are provided. In some embodiments, the system may be configured to provide adaptive notifications from a client device to a user of that client device. The system may include at least one client device which includes a biometric sensor that is configured to provide biometric data, such as a heart rate, perspiration rate, a respiration rate, or any other type of biometric data of the user of that client device. The biometric data of the user may then be used to provide adaptive notifications to the user. Based on the biometric data of the user, notifications from a client device may be disabled and enabled. In further embodiments, based on the biometric data of the user, notifications from a client device may be produced at increasing or changing intensity levels as the biometric data of the user increases or changes.

### FIELD OF THE INVENTION

This patent specification relates to the field of electronic device notifications. More specifically, this patent specification relates to systems and methods that are configured to provide adaptive notifications from an electronic device.

### BACKGROUND

Electronic devices, including tablet computers, smartphones, smartwatches, and the like, are configured to provide notifications to users of these devices. These notifications may be visual, such as by being displayed on a display screen of an electronic device, tactile or vibrational, and/or audible, such as by emitting sound and ringtones. Electronic devices are configured to produce audible notifications at different intensity levels from silent to very loud.

Typically, if a user desires to change the type and/or intensity of notifications provided by an electronic device, the user must manipulate the device settings to select the desired type and/or intensity of the notifications. Unfortunately, even the most diligent users may forget to adjust the notification settings resulting in interrupted sleep of the user, awkward social situations, and missed notifications. While some electronic devices offer the ability to automatically change the type and/or intensity of notifications provided by an electronic device, this ability is limited to changing the notification based on the time or day it is received. Still further devices offer the ability to automatically change the type and/or intensity of notifications provided by an electronic device, however, this ability is limited to changing the notification based on the presence of a second electronic device being detected by the notifying electronic device. For example, notifications from a smartphone are silenced when the smartphone is linked to a Bluetooth headset.

Therefore, a need exists for novel systems and methods that are configured to provide adaptive notifications from an electronic device. A further need exists for novel systems and methods that are configured to provide adaptive notifications from an electronic device that does not require a user to manipulate the device settings to select the desired type and/or intensity of the notifications. Finally, a need exists for novel systems and methods that are configured to provide adaptive notifications from an electronic device that are not based on the time the notification is received, the date the notification is received, or on the presence detection of other electronic devices.

### BRIEF SUMMARY OF THE INVENTION

An adaptive client device notification system and methods are provided. In some embodiments, the system may be configured to provide adaptive notifications from a client device to a user of that client device. A client device may be configured to access a data network through a network connection and may include smartphones, tablet computers, smartwatches, fitness trackers, and the like. The system may include at least one client device which includes a biometric sensor that is configured to provide biometric data, such as a heart rate, perspiration rate, a respiration rate, or any other type of biometric data of the user of that client device. The biometric data of the user may then be used to provide adaptive notifications to the user. Based on the biometric data of the user, notifications from a client device may be disabled and enabled. In preferred embodiments, notifications from a client device may be disabled by terminating the network connection of the client device to the data network, and notifications from a client device may be enabled by enabling the network connection of the client device to the data network. In further embodiments, based on the biometric data of the user, notifications from a client device may be produced at increasing or changing intensity levels as the biometric data of the user increases or changes.

In some embodiments, a method for providing adaptive notifications from a client device configured to access a data network through a network connection may comprise preventing notifications from the client device and the method may include the steps of: determining a minimum biometric data value of user in a period of time; assigning a minimum biometric data threshold; determining when the biometric data of the user is within the minimum biometric data threshold; and preventing the client device from producing a notification when the biometric data of the user is within the minimum biometric data threshold. In further embodiments, the client device may be prevented from producing a notification by terminating the network connection of the client device to the data network.

According to another embodiment consistent with the principles of the invention, a method for providing adaptive notifications from a client device configured to access a data network through a network connection is provided. The method may include the steps of: determining a minimum biometric data value of user in a period of time; assigning a minimum biometric data threshold, an intermediate biometric data threshold, and a maximum biometric data threshold; determining when the biometric data of the user is within the minimum biometric data threshold, the intermediate biometric data threshold, or the maximum biometric data threshold; preventing the client device from producing a notification when the biometric data of the user is within the minimum biometric data threshold, enabling the client device to produce a notification at a first notification level when the biometric data of the user is within the intermediate biometric data threshold, and enabling the client device to produce a notification at a second notification level when the biometric data of the user is within the maximum biometric data threshold. In further embodiments, the client device may be prevented from producing a notification by terminating the network connection of the client device to the data network.

### BRIEF DESCRIPTION OF THE DRAWINGS

Some embodiments of the present invention are illustrated as an example and are not limited by the figures of the accompanying drawings, in which like references may indicate similar elements and in which:

FIG. 1 depicts an illustrative example of some of the components and computer implemented methods which may be found in an adaptive client device notification system according to various embodiments described herein.

FIG. 2 illustrates a block diagram illustrating an example of a client device which may be used by the system as described in various embodiments herein.

FIG. 3 a block diagram illustrating an example of a server which may be used by the system as described in various embodiments herein.

FIG. 4 shows a block diagram illustrating some modules of an adaptive client device notification system which may function as software rules engines according to various embodiments described herein.

FIG. 5 depicts a block diagram of an example of a method for preventing notifications according to various embodiments described herein.

FIG. 6 illustrates an example of a method for providing adaptive notifications according to various embodiments described herein.

FIG. 7 shows an example of a wearable first client device which has a biometric sensor and which is in electronic communication with a second client device that is enabled to provide adaptive notifications to the user of the first and second client devices according to various embodiments described herein.

FIG. 8 depicts an example of a wearable first client device which has a biometric sensor and which is in electronic communication with a second client device that is prevented from providing adaptive notifications to the user of the first and second client devices according to various embodiments described herein.

FIG. 9 illustrates an example of a wearable client device which has an integral biometric sensor and which is enabled to provide adaptive notifications to a user.

FIG. 10 shows an example of a wearable client device which has an integral biometric sensor and which is prevented from providing adaptive notifications to a user.

### DETAILED DESCRIPTION OF THE INVENTION

The terminology used herein is for the purpose of describing particular embodiments only and is not intended to be limiting of the invention. As used herein, the term “and/or” includes any and all combinations of one or more of the associated listed items. As used herein, the singular forms “a,” “an,” and “the” are intended to include the plural forms as well as the singular forms, unless the context clearly indicates otherwise. It will be further understood that the terms “comprises” and/or “comprising,” when used in this specification, specify the presence of stated features, steps, operations, elements, and/or components, but do not preclude the presence or addition of one or more other features, steps, operations, elements, components, and/or groups thereof.

Unless otherwise defined, all terms (including technical and scientific terms) used herein have the same meaning as commonly understood by one having ordinary skill in the art to which this invention belongs. It will be further understood that terms, such as those defined in commonly used dictionaries, should be interpreted as having a meaning that is consistent with their meaning in the context of the relevant art and the present disclosure and will not be interpreted in an idealized or overly formal sense unless expressly so defined herein.

### Definitions

As used herein, the term “computer” refers to a machine, apparatus, or device that is capable of accepting and performing logic operations from software code. The term “application”, “software”, “software code” or “computer software” refers to any set of instructions operable to cause a computer to perform an operation. Software code may be operated on by a “rules engine” or processor. Thus, the methods and systems of the present invention may be performed by a computer based on instructions received by computer software.

The term “electronic device” as used herein is a type of computer comprising circuitry and configured to generally perform functions such as recording audio, photos, and videos; displaying or reproducing audio, photos, and videos; storing, retrieving, or manipulation of electronic data; providing electrical communications and network connectivity; or any other similar function. Non-limiting examples of electronic devices include: personal computers (PCs), workstations, laptops, tablet PCs including the iPad, cell phones including iOS phones made by Apple Inc., Android OS phones, Microsoft OS phones, Blackberry phones, digital music players, or any electronic device capable of running computer software and displaying information to a user, memory cards, other memory storage devices, digital cameras, external battery packs, external charging devices, and the like. Certain types of electronic devices which are portable and easily carried by a person from one location to another may sometimes be referred to as a “portable electronic device” or “portable device”. Some non-limiting examples of portable devices include: cell phones, smartphones, tablet computers, laptop computers, wearable computers such as Apple Watch, other smartwatches, Fitbit, other wearable fitness trackers, Google Glasses, and the like.

The term “client device” or sometimes “electronic device” or just “device” as used herein is a type of computer generally operated by a person or user of the system. In some embodiments, a client device is a smartphone or computer configured to receive and transmit data to a server or other electronic device which may be operated locally or in the cloud. Non-limiting examples of client devices include: personal computers (PCs), workstations, laptops, tablet PCs including the iPad, cell phones including iOS phones made by Apple Inc., Android OS phones, Microsoft OS phones, Blackberry phones, or generally any electronic device capable of running computer software and displaying information to a user. Certain types of client devices which are portable and easily carried by a person from one location to another may sometimes be referred to as a “mobile device” or “portable device”. Some non-limiting examples of mobile devices include: cell phones, smartphones, tablet computers, laptop computers, wearable computers such as Apple Watch, other smartwatches, Fitbit, other wearable fitness trackers, Google Glasses, and the like.

The term “computer readable medium” as used herein refers to any medium that participates in providing instructions to the processor for execution. A computer readable medium may take many forms, including but not limited to, non-volatile media, volatile media, and transmission media. Non-volatile media includes, for example, optical, magnetic disks, and magneto-optical disks, such as the hard disk or the removable media drive. Volatile media includes dynamic memory, such as the main memory. Transmission media includes coaxial cables, copper wire and fiber optics, including the wires that make up the bus. Transmission media may also take the form of acoustic or light waves, such as those generated during radio wave and infrared data communications.

As used herein the term “data network” or “network” shall mean an infrastructure capable of connecting two or more computers such as client devices either using wires or wirelessly allowing them to transmit and receive data. Non-limiting examples of data networks may include the internet or wireless networks (i.e. a “wireless network”) including Wifi, Bluetooth, and cellular networks. For example, a network may include a local area network (LAN), a wide area network (WAN) (e.g., the Internet), a mobile relay network, a metropolitan area network (MAN), an ad hoc network, a telephone network (e.g., a Public Switched Telephone Network (PSTN)), a cellular network, or a voice-over-IP (VoIP) network.

As used herein, the term “database” shall generally mean a digital collection of data or information. The present invention uses novel methods and processes to store, link, and modify information such digital images and videos and user profile information. For the purposes of the present disclosure, a database may be stored on a remote server and accessed by a client device through the internet (i.e., the database is in the cloud) or alternatively in some embodiments the database may be stored on the client device or remote computer itself (i.e., local storage). A “data store” as used herein may contain or comprise a database (i.e. information and data from a database may be recorded into a medium on a data store).

In describing the invention, it will be understood that a number of techniques and steps are disclosed. Each of these has individual benefit and each can also be used in conjunction with one or more, or in some cases all, of the other disclosed techniques. Accordingly, for the sake of clarity, this description will refrain from repeating every possible combination of the individual steps in an unnecessary fashion. Nevertheless, the specification and claims should be read with the understanding that such combinations are entirely within the scope of the invention and the claims.

New adaptive client device notification system and methods are discussed herein. In the following description, for purposes of explanation, numerous specific details are set forth in order to provide a thorough understanding of the present invention. It will be evident, however, to one skilled in the art that the present invention may be practiced without these specific details.

The present disclosure is to be considered as an exemplification of the invention, and is not intended to limit the invention to the specific embodiments illustrated by the figures or description below.

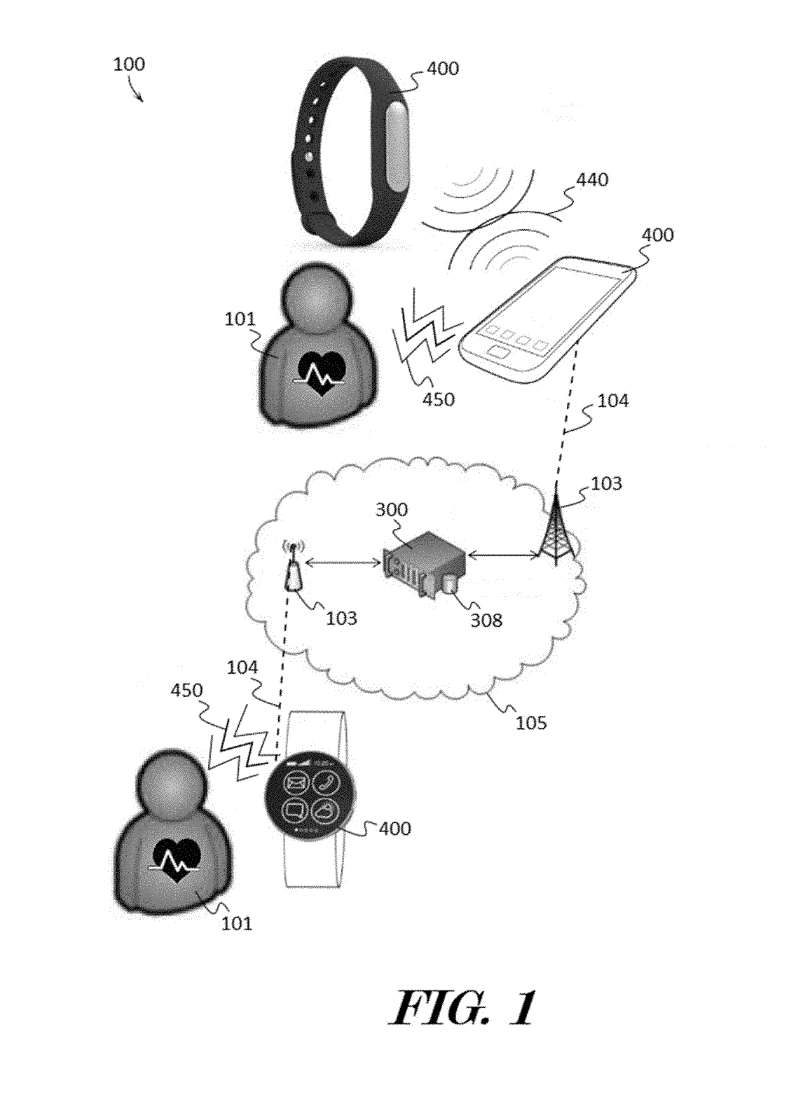

The present invention will now be described by example and through referencing the appended figures representing preferred and alternative embodiments. As perhaps best shown by FIG. 1, an illustrative example of some of the physical components which an adaptive client device notification system (“the system”) 100 may comprise according to some embodiments is presented. The system 100 is configured to provide adaptive notifications from a client device 400 to a user 101 of that client device 400. A client device 400 may include smartphones, tablet computers, smartwatches, fitness trackers, and the like. In some embodiments, a client device 400 may comprise a network connection 104 which may facilitate the transfer of data and information between one or more access points 103, client devices 400, servers 300, and/or data stores 308 over a data network 105. In further embodiments, in response to data received from a data network 105, a client device 400 may be configured to provide an audio notification, a visual notification, and/or a tactile notification to the user 101. For example, a notification from a client device 400 may indicate that the client device 400 has received a text message, an email, a phone call, social media update, and the like.

In this example, the system 100 comprises at least one client device 400 (but preferably more than two client devices 400) configured to be operated by one or more users 101. Client devices 400 can be mobile devices, such as laptops, tablet computers, personal digital assistants, smart phones, and the like, that are equipped with a wireless network interface capable of sending data to one or more servers 300 with access to one or more data stores 308 over a network 105 such as a wireless local area network (WLAN). Additionally, client devices 400 can be fixed devices, such as desktops, workstations, and the like, that are equipped with a wireless or wired network interface capable of sending data to one or more servers 300 with access to one or more data stores 308 over a wireless or wired local area network 105. The present invention may be implemented on at least one client device 400 and/or server 300 programmed to perform one or more of the steps described herein. In some embodiments, more than one client device 400 and/or server 300 may be used, with each being programmed to carry out one or more steps of a method or process described herein.

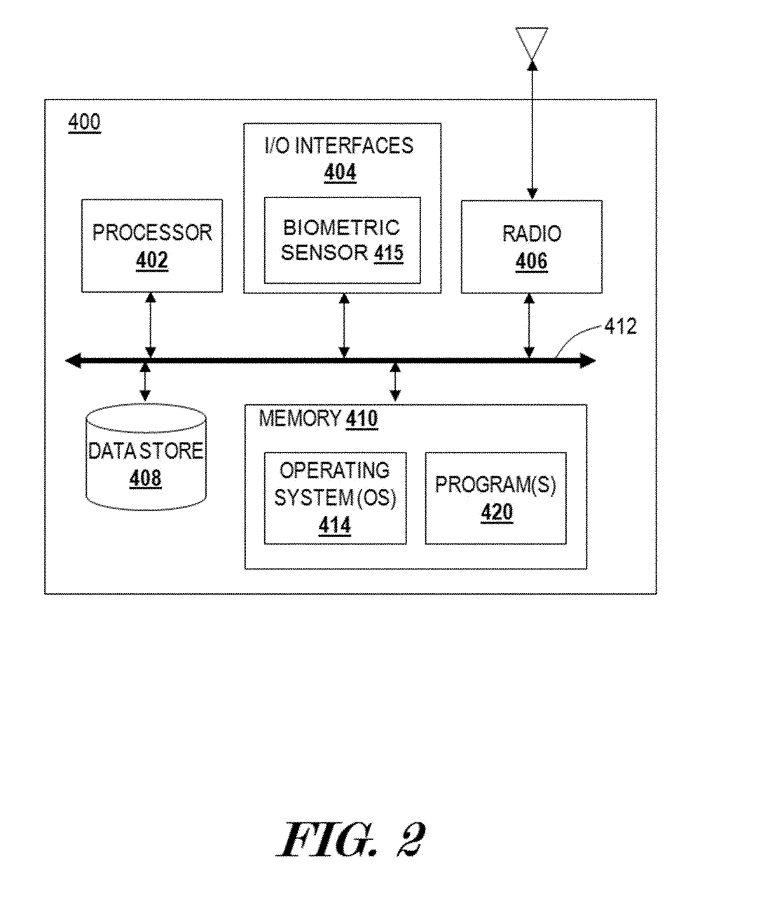

The system 100 may include at least one client device 400 which includes a biometric sensor 415 (FIGS. 2, 6, 7) that is configured to provide biometric data, such as a heart beat rate or a respiration rate, of the user 101 of that client device 400. The biometric data of the user 101 may then be used to provide adaptive notifications 450 to the user 101.

In some embodiments, the system may comprise a wearable client device 400 which has an integral biometric sensor 415 and which is configured to provide notifications 450 to a user 101. Notifications provided by the wearable client device 400 may be adapted to the biometric data provided by the biometric sensor 415 of the wearable client device 400. For example, a wearable client device 400, such as a fitness tracker or smartwatch, may include a biometric sensor 415 which is configured to measure the heart rate of the user 101 wearing that client device 400. As the heart rate of the user 101 increases, notifications 450 from the wearable client device 400 may be enabled and/or increased in intensity. As the heart rate of the user 101 decreases, notifications 450 from the wearable client device 400 may be decreased in intensity and/or disabled.

In some embodiments, the system 100 may comprise a wearable first client device 400 which has a biometric sensor 415 and which is in electronic communication 440 with a second client device 400 that is configured to provide notifications 450 to the user 101 of the first and second client devices 400. Notifications 450 provided by the second client device 400 may be adapted to the biometric data provided by the biometric sensor 415 of the first client device 400. For example, a wearable first client device 400, such as a fitness tracker or smartwatch, may include a biometric sensor 415 which is configured to measure the respiration rate of the user 101 wearing that first client device 400. The respiration rate of the user 101 may then be communicated to a second client device 400, such as a smartphone, which is configured to provide notifications 450 to the user 101. As the respiration rate of the user 101 increases, notifications 450 from the second client device 400 may be enabled and/or increased in intensity. As the respiration rate of the user 101 decreases, notifications 450 from the second client device 400 may be decreased in intensity and/or disabled.

Referring now to FIG. 2, in an exemplary embodiment, a block diagram illustrates a client device 400 of which one or more may be used in the system 100 or the like. The client device 400 can be a digital device that, in terms of hardware architecture, generally includes a processor 402, input/output (I/O) interfaces 404, a radio 406, a data store 408, and memory 410. It should be appreciated by those of ordinary skill in the art that FIG. 2 depicts the client device 400 in an oversimplified manner, and a practical embodiment may include additional components and suitably configured processing logic to support known or conventional operating features that are not described in detail herein. The components (402, 404, 406, 408, and 410) are communicatively coupled via a local interface 412. The local interface 412 can be, for example but not limited to, one or more buses or other wired or wireless connections, as is known in the art. The local interface 412 can have additional elements, which are omitted for simplicity, such as controllers, buffers (caches), drivers, repeaters, and receivers, among many others, to enable communications. Further, the local interface 412 may include address, control, and/or data connections to enable appropriate communications among the aforementioned components.

The processor 402 is a hardware device for executing software instructions. The processor 402 can be any custom made or commercially available processor, a central processing unit (CPU), an auxiliary processor among several processors associated with the client device 400, a semiconductor-based microprocessor (in the form of a microchip or chip set), or generally any device for executing software instructions. When the client device 400 is in operation, the processor 402 is configured to execute software stored within the memory 410, to communicate data to and from the memory 410, and to generally control operations of the client device 400 pursuant to the software instructions. In an exemplary embodiment, the processor 402 may include a mobile optimized processor such as optimized for power consumption and mobile applications.

The I/O interfaces 404 can be used to receive data and user input and/or for providing system output. User input can be provided via a plurality of I/O interfaces 404, such as a keypad, a touch screen, a camera, a microphone, a scroll ball, a scroll bar, buttons, bar code scanner, voice recognition, eye gesture, and the like. In some embodiments, an I/O interface 404 may comprise a biometric sensor 415 which is able to measure and/or record biometric data from a user 101. A biometric sensor 415 is a transducer that converts biometric data (heart rate, respiration rate, perspiration rate, oxygen level of the blood, or any other measurable type of physiological data) of a person into an electrical signal. Generally, the biometric sensor 415 may read or measure pressure, temperature, light, speed, electrical capacity or other kinds of energies. Different technologies can be applied to achieve this conversion using common digital cameras or more sophisticated combinations or networks of sensors. Example biometric sensors include heart rate sensors, pulse oximeter sensor, pulse oximetry sensors, Bio-Impedance Electrical Analysis (BIA) sensors, and respiration rate sensors.

System output and visual notifications 450 can be provided via a display device such as a liquid crystal display (LCD), touch screen, and the like. The I/O interfaces 404 can also include, for example, a serial port, a parallel port, a small computer system interface (SCSI), an infrared (IR) interface, a radio frequency (RF) interface, a universal serial bus (USB) interface, and the like. The I/O interfaces 404 can include a graphical user interface (GUI) that enables a user to interact with the client device 400. Additionally, the I/O interfaces 404 may be used to output notifications 450 to a user 101 and can include a speaker or other sound emitting device configured to emit audio notifications 450, a vibrational device configured to vibrate, shake, or produce any other series of rapid and repeated movements to produce haptic notifications, and/or a light emitting diode (LED) or other light emitting element which may be configured to illuminate to provide a visual notification 450.

The radio 406 enables wireless communication to an external access device or network. Any number of suitable wireless data communication protocols, techniques, or methodologies can be supported by the radio 406, including, without limitation: RF; IrDA (infrared); Bluetooth; ZigBee (and other variants of the IEEE 802.15 protocol); IEEE 802.11 (any variation); IEEE 802.16 (WiMAX or any other variation); Direct Sequence Spread Spectrum; Frequency Hopping Spread Spectrum; Long Term Evolution (LTE); cellular/wireless/cordless telecommunication protocols (e.g. 3G/4G, etc.); wireless home network communication protocols; paging network protocols; magnetic induction; satellite data communication protocols; wireless hospital or health care facility network protocols such as those operating in the WMTS bands; GPRS; proprietary wireless data communication protocols such as variants of Wireless USB; and any other protocols for wireless communication. The data store 408 may be used to store data. The data store 408 may include any of volatile memory elements (e.g., random access memory (RAM, such as DRAM, SRAM, SDRAM, and the like)), nonvolatile memory elements (e.g., ROM, hard drive, tape, CDROM, and the like), and combinations thereof. Moreover, the data store 408 may incorporate electronic, magnetic, optical, and/or other types of storage media.

The memory 410 may include any of volatile memory elements (e.g., random access memory (RAM, such as DRAM, SRAM, SDRAM, etc.)), nonvolatile memory elements (e.g., ROM, hard drive, etc.), and combinations thereof. Moreover, the memory 410 may incorporate electronic, magnetic, optical, and/or other types of storage media. Note that the memory 410 may have a distributed architecture, where various components are situated remotely from one another, but can be accessed by the processor 402. The software in memory 410 can include one or more software programs, each of which includes an ordered listing of executable instructions for implementing logical functions. In the example of FIG. 2, the software in the memory system 410 includes a suitable operating system (O/S) 414 and programs 420.

The operating system 414 essentially controls the execution of other computer programs, and provides scheduling, input-output control, file and data management, memory management, and communication control and related services. The operating system 414 may be, for example, LINUX (or another UNIX variant), Android (available from Google), Symbian OS, Microsoft Windows CE, Microsoft Windows 7 Mobile, Microsoft Windows 10, iOS (available from Apple, Inc.), webOS (available from Hewlett Packard), Blackberry OS (Available from Research in Motion), and the like. The programs 420 may include various applications, add-ons, etc. configured to provide end user functionality with the client device 400. For example, exemplary programs 420 may include, but not limited to, a web browser, social networking applications, streaming media applications, games, mapping and location applications, electronic mail applications, financial applications, and the like. In a typical example, the end user typically uses one or more of the programs 420 along with a network such as the system 100.

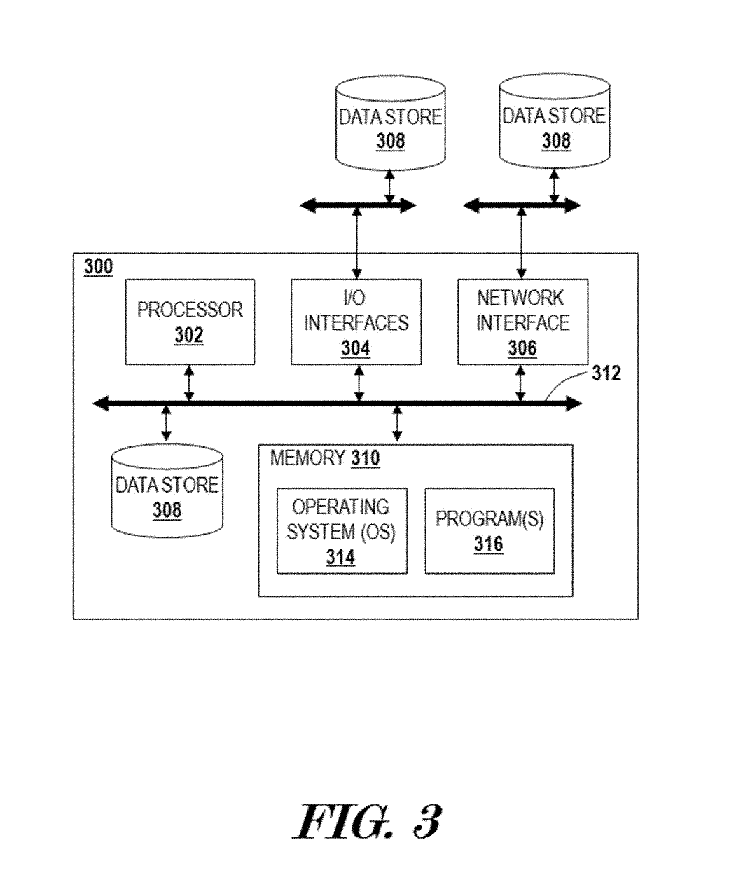

Referring now to FIG. 3, in an exemplary embodiment, a block diagram illustrates a server 300 of which one or more may be used in the system 100 or standalone. The server 300 may be a digital computer that, in terms of hardware architecture, generally includes a processor 302, input/output (I/O) interfaces 304, a network interface 306, a data store 308, and memory 310. It should be appreciated by those of ordinary skill in the art that FIG. 3 depicts the server 300 in an oversimplified manner, and a practical embodiment may include additional components and suitably configured processing logic to support known or conventional operating features that are not described in detail herein. The components (302, 304, 306, 308, and 310) are communicatively coupled via a local interface 312. The local interface 312 may be, for example but not limited to, one or more buses or other wired or wireless connections, as is known in the art. The local interface 312 may have additional elements, which are omitted for simplicity, such as controllers, buffers (caches), drivers, repeaters, and receivers, among many others, to enable communications. Further, the local interface 312 may include address, control, and/or data connections to enable appropriate communications among the aforementioned components.

The processor 302 is a hardware device for executing software instructions. The processor 302 may be any custom made or commercially available processor, a central processing unit (CPU), an auxiliary processor among several processors associated with the server 300, a semiconductor-based microprocessor (in the form of a microchip or chip set), or generally any device for executing software instructions. When the server 300 is in operation, the processor 302 is configured to execute software stored within the memory 310, to communicate data to and from the memory 310, and to generally control operations of the server 300 pursuant to the software instructions. The I/O interfaces 304 may be used to receive user input from and/or for providing system output to one or more devices or components. User input may be provided via, for example, a keyboard, touch pad, and/or a mouse. System output may be provided via a display device and a printer (not shown). I/O interfaces 304 may include, for example, a serial port, a parallel port, a small computer system interface (SCSI), a serial ATA (SATA), a fibre channel, Infiniband, iSCSI, a PCI Express interface (PCI-x), an infrared (IR) interface, a radio frequency (RF) interface, and/or a universal serial bus (USB) interface.

The network interface 306 may be used to enable the server 300 to communicate on a network, such as the Internet, the data network 105, the enterprise, and the like, etc. The network interface 306 may include, for example, an Ethernet card or adapter (e.g., 10BaseT, Fast Ethernet, Gigabit Ethernet, 10 GbE) or a wireless local area network (WLAN) card or adapter (e.g., 802.11a/b/g/n). The network interface 306 may include address, control, and/or data connections to enable appropriate communications on the network. A data store 308 may be used to store data. The data store 308 may include any of volatile memory elements (e.g., random access memory (RAM, such as DRAM, SRAM, SDRAM, and the like)), nonvolatile memory elements (e.g., ROM, hard drive, tape, CDROM, and the like), and combinations thereof. Moreover, the data store 308 may incorporate electronic, magnetic, optical, and/or other types of storage media. In one example, the data store 308 may be located internal to the server 300 such as, for example, an internal hard drive connected to the local interface 312 in the server 300. Additionally in another embodiment, the data store 308 may be located external to the server 300 such as, for example, an external hard drive connected to the I/O interfaces 304 (e.g., SCSI or USB connection). In a further embodiment, the data store 308 may be connected to the server 300 through a network, such as, for example, a network attached file server.

The memory 310 may include any of volatile memory elements (e.g., random access memory (RAM, such as DRAM, SRAM, SDRAM, etc.)), nonvolatile memory elements (e.g., ROM, hard drive, tape, CDROM, etc.), and combinations thereof. Moreover, the memory 310 may incorporate electronic, magnetic, optical, and/or other types of storage media. Note that the memory 310 may have a distributed architecture, where various components are situated remotely from one another, but can be accessed by the processor 302. The software in memory 310 may include one or more software programs, each of which includes an ordered listing of executable instructions for implementing logical functions. The software in the memory 310 may include a suitable operating system (O/S) 314 and one or more programs 320.

The operating system 314 essentially controls the execution of other computer programs, such as the one or more programs 320, and provides scheduling, input-output control, file and data management, memory management, and communication control and related services. The operating system 314 may be, for example Windows NT, Windows 2000, Windows XP, Windows Vista, Windows 7, Windows 8, Windows 10, Windows Server 2003/2008 (all available from Microsoft, Corp. of Redmond, Wash.), Solaris (available from Sun Microsystems, Inc. of Palo Alto, Calif.), LINUX (or another UNIX variant) (available from Red Hat of Raleigh, N.C. and various other vendors), Android and variants thereof (available from Google, Inc. of Mountain View, Calif.), Apple OS X and variants thereof (available from Apple, Inc. of Cupertino, Calif.), or the like. The one or more programs 320 may be configured to implement the various processes, algorithms, methods, techniques, etc. described herein.

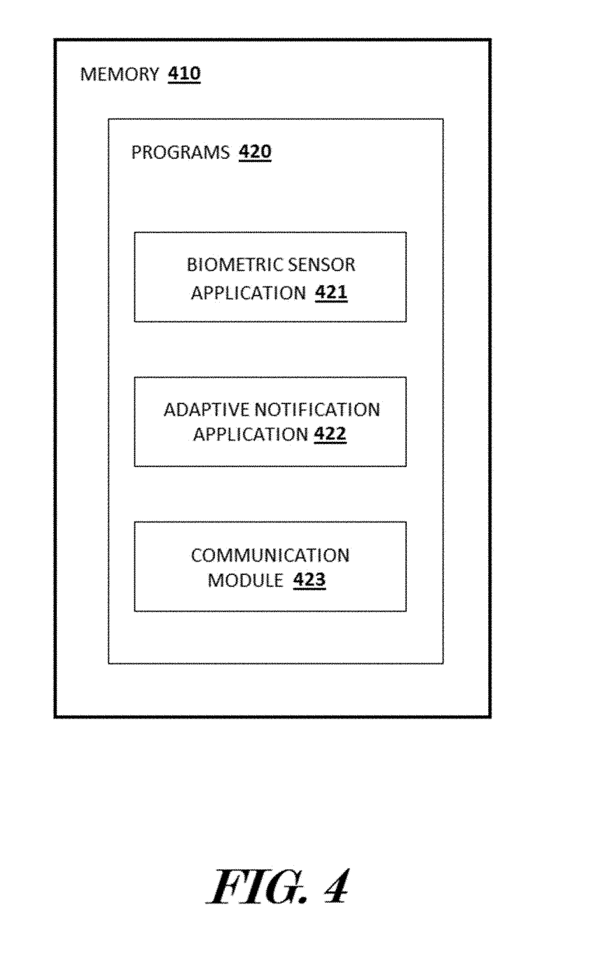

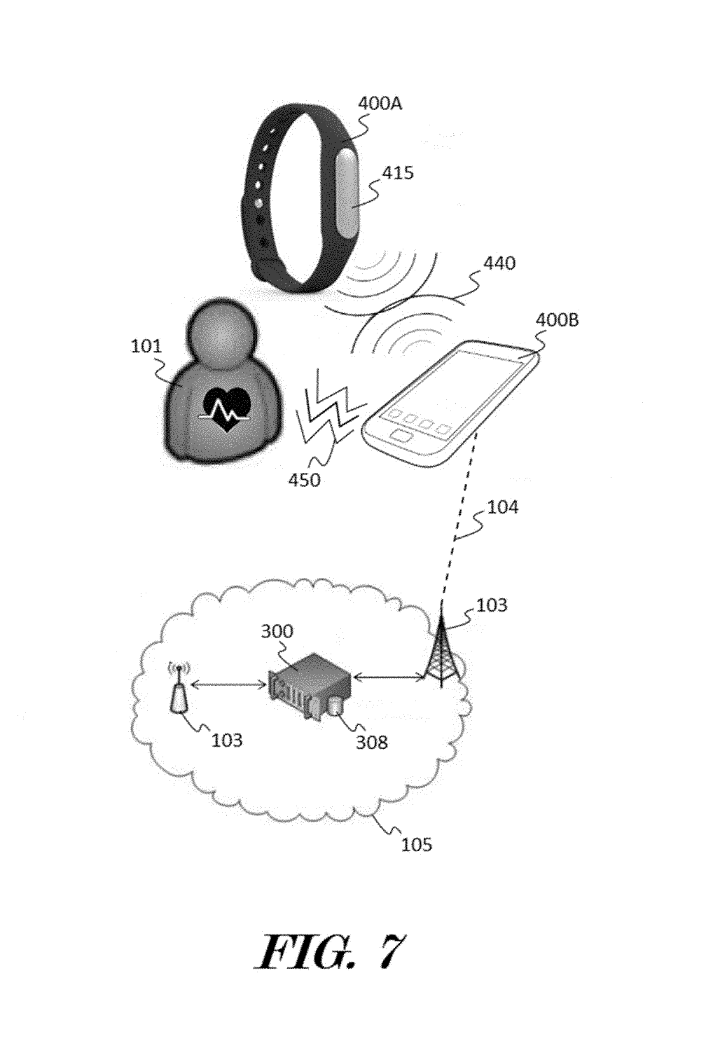

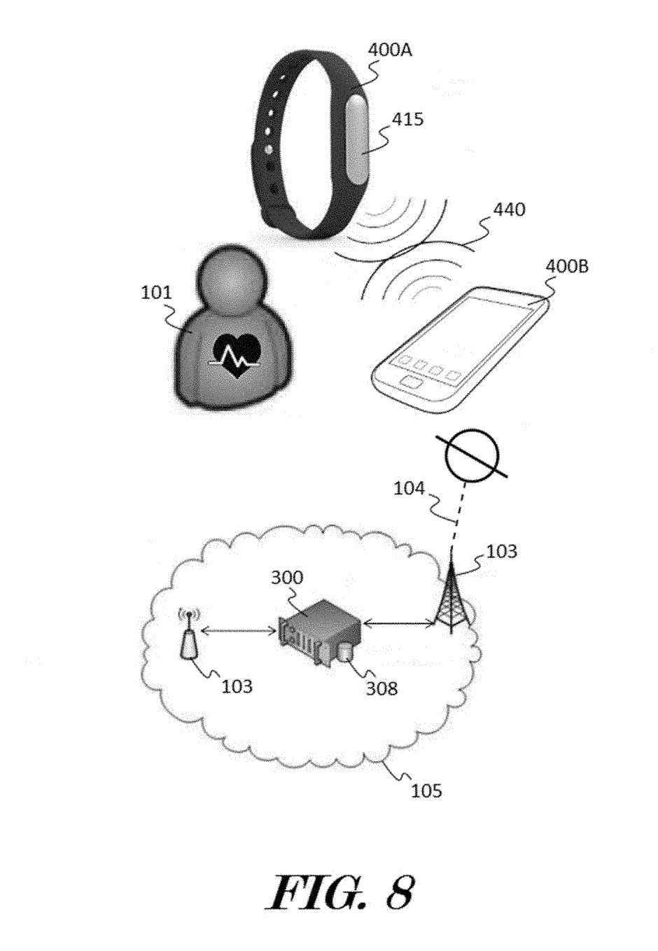

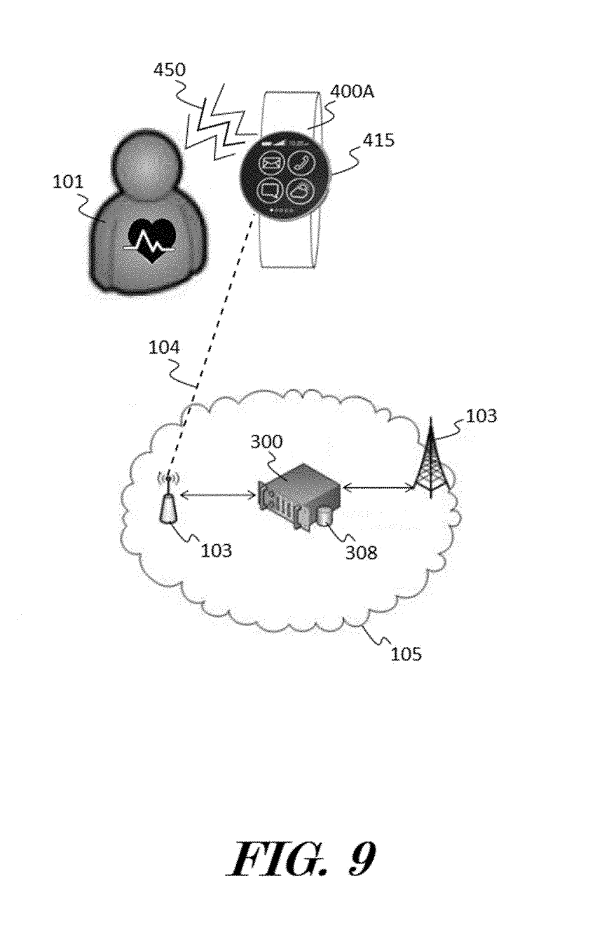

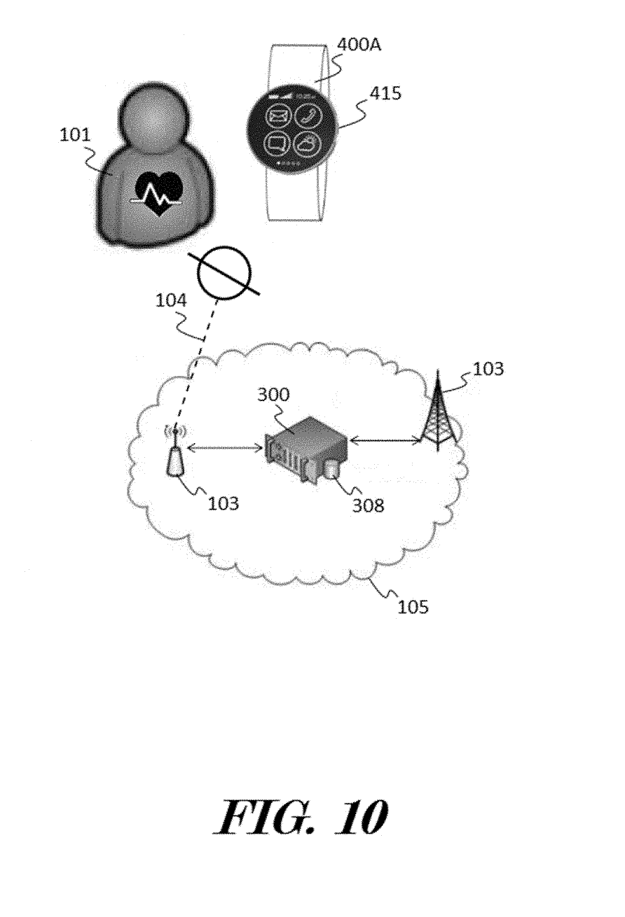

FIG. 4 depicts a block diagram showing some software rules engines which may be found in a system 100 and which may optionally be configured to run on a client device 400 according to various embodiments described herein. In some embodiments, one or more client devices 400 may be configured to run one or more software rules engines or programs such as a biometric sensor application 421, an adaptive notification application 422, and/or a communication module 423. In this embodiment, the engines 421, 422, 423, are configured to run on at least one client device 400, and optionally on two or more client devices 400 of which at least one client device 400 may be in electronic communication 440 a server 300 on a network 105. A client device 400 in electronic communication with a server 300 may receive data from the server 300 through a network connection 104. In response to data received from a data network 105, a client device 400 may be configured to provide an audio notification 450, a visual notification 450, and/or a tactile notification 450 to the user 101. In some embodiments, a biometric sensor application 421, an adaptive notification application 422, and/or a communication module 423 may be configured to run on a client device 400 and/or server 300 with data transferred to and from one or more servers 300 through a network 105 as shown in the examples of FIGS. 9 and 10. In further embodiments, a biometric sensor application 421 and a communication module 423 may be configured to run on a first client device 400 and an adaptive notification application 422 and a communication module 423 may be configured to run on a second client device 400 as shown in FIGS. 7 and 8. The first client device 400 may be in electronic communication 440 with the second client device 400 while the second client device 400 may also be in electronic communication with a server 300 through a network 105.

The system 100 may comprise a database stored on a data store 408, accessible to a biometric sensor application 421, an adaptive notification application 422, and/or a communication module 423. In some embodiments, the database may comprise data and information on one or more users 101. In further embodiments, the database may comprise biometric data of a user 101 which has been recorded or detected by a biometric sensor 415. The biometric data may include information describing a greatest or a maximum value of the biometric data recorded by a biometric sensor 415 over a period of time from a user 101 such as a maximum heart rate, respiration rate, and the like. The biometric data may also include information describing a minimum value of the biometric data recorded by a biometric sensor 415 over a period of time from a user 101 such as a minimum heart rate, respiration rate, and the like. The biometric data may also include information describing an average value of the biometric data recorded by a biometric sensor 415 over a period of time from a user 101 such as an average heart rate, respiration rate, and the like. Additionally, the biometric data in a database stored on a data store 408 may also include information describing one or more biometric data thresholds which may be described as a percentage of a maximum biometric value, minimum biometric value, intermediate biometric data thresholds, and/or average biometric value of a user.

The biometric sensor application 421, preferably run on a client device 400 and more preferably run on a client device which comprises a biometric sensor 415, may be configured to detect, record, or otherwise capture biometric data provided by a biometric sensor 415. The biometric sensor application 421 may communicate the biometric data to the adaptive notification application 422 and/or to the communication module 423. In some embodiments, the biometric sensor application 421 may be integral with a biometric sensor so that the biometric data detected by the biometric sensor may be communicated directly to the adaptive notification application 422 and/or to the communication module 423 by the biometric sensor application 421. In other embodiments, the biometric sensor application 421 may receive and/or convert data from a biometric sensor 415 into biometric data which may then be communicated to the adaptive notification application 422 and/or to the communication module 423 by the biometric sensor application 421.

The adaptive notification application 422, preferably run on a client device 400 and optionally run on a server 300, may be configured to receive biometric data provided by the biometric sensor application 421 and to use the biometric data to provide adaptive notifications 450 from a client device 400 to a user 101 of that client device 400. In some embodiments, the adaptive notification application 422 may be configured to determine a maximum biometric value, a minimum biometric value, and/or an average biometric value of a user 101 over a period of time. For example, the adaptive notification application 422 may be provided with heart rate biometric data of a user 101 over a period of 24 hours and may identify the maximum heart rate, minimum heart rate, and/or average heart rate of the user 101 in the 24 hour period in order to determine the maximum, minimum, and/or average heart rate value of the user 101.

In some embodiments, the adaptive notification application 422 may be configured to assign one or more biometric data thresholds to a user 101 based on a maximum biometric value, a minimum biometric value, and/or an average biometric value of a user 101 over a period of time. A biometric data threshold may describe a range of biometric data values into which biometric data provided by the biometric sensor application 421 may fall. The adaptive notification application 422 may be configured to assign or create any number of biometric data thresholds. In preferred embodiments, the adaptive notification application 422 may assign a minimum biometric data threshold, one or more intermediate biometric data thresholds, and/or a maximum biometric data threshold.

A minimum biometric data threshold may describe a minimum range of biometric data values into which biometric data provided by the biometric sensor application 421 may fall. In some embodiments, a minimum biometric data threshold may be assigned as a range of biometric data which includes the minimum biometric data value of a user 101 recorded over a period of time. For example, a minimum biometric data threshold may be between 90 and 120 percent of a minimum biometric value recorded by a biometric sensor 415 over a period of time from a user 101. In a further example, a minimum biometric data threshold may be between 100 and 110 percent of a minimum biometric value recorded by a biometric sensor 415 over a period of time from a user 101. In another example, a minimum biometric data threshold may comprise a cutoff value, such as any value less than 110 percent of the minimum biometric data value recorded in a period of time.

An intermediate biometric data threshold may describe an intermediate range of biometric data values into which biometric data provided by the biometric sensor application 421 may fall. In some embodiments, an intermediate biometric data threshold may be assigned as a range of biometric data which preferably excludes the minimum and/or maximum biometric data values of a user recorded 101 over a period of time. For example, an intermediate biometric data threshold may be between 121 and 180 percent of a minimum biometric value recorded by a biometric sensor 415 over a period of time from a user 101. In another example, an intermediate biometric data threshold may be between 50 and 150 percent of the average biometric value recorded by a biometric sensor 415 over a period of time from a user 101. In a further example, an intermediate biometric data threshold may be between 20 and 80 percent of the maximum biometric value recorded by a biometric sensor 415 over a period of time from a user 101. In still further embodiments, the adaptive notification application 422 may be configured to assign a first intermediate biometric data threshold, a second intermediate biometric data threshold, a third intermediate biometric data threshold, a fourth intermediate biometric data threshold, a fifth intermediate biometric data threshold, or more intermediate biometric data thresholds which preferably describe a range of biometric data values into which biometric data provided by the biometric sensor application 421 may fall and which also do not overlap with any other biometric data thresholds.

A maximum biometric data threshold may describe a maximum range of biometric data values into which biometric data provided by the biometric sensor application 421 may fall. In some embodiments, a maximum biometric data threshold may be assigned as a range of biometric data based on the minimum biometric data value of a user 101 recorded over a period of time. For example, a maximum biometric data threshold may be between 150 and 250 percent of a minimum biometric value recorded by a biometric sensor 415 over a period of time from a user 101. In another example, a maximum biometric data threshold may be greater than or equal to 200 percent of a minimum biometric value recorded by a biometric sensor 415 over a period of time from a user 101. In alternative embodiments, a maximum biometric data threshold may be assigned by a range of biometric data which includes the maximum biometric data value of a user 101 recorded over a period of time. For example, a maximum biometric data threshold may be between 60 and 140 percent of a maximum biometric value recorded by a biometric sensor 415 over a period of time from a user 101. In another example, a maximum biometric data threshold may be between 80 and 110 percent of a maximum biometric value recorded by a biometric sensor 415 over a period of time from a user 101.

The adaptive notification application 422 may also be configured to determine if biometric data provided by the biometric sensor application 421 is within a biometric data threshold. For example, biometric data received by the adaptive notification application 422 may comprise the heart rate of the user 101 and a minimum biometric data threshold may be assigned as 65 or less beats per minute. When the heart rate of the user is 65 beats or less per minute, the adaptive notification application 422 may determine that the heart rate of the user 101 is within the minimum biometric data threshold.

The adaptive notification application 422 may be further configured to modify or adapt notifications 450 produced by a client device 400 based on which biometric data threshold the biometric data of the user 101 falls into. Each biometric data threshold may correspond to a notification level of a client device 400 of the user 101. A notification level may describe a level or intensity of notification 450 which may be provided by a client device 400. Notifications 450 provided by client devices are typically characterized into discrete levels such as silent or none, intermediate, and maximum. Additionally, intermediate levels may be further broken up into any number of increasing levels between the silent level and maximum level, such as a first intermediate level, second intermediate level, third intermediate level, fourth intermediate level, etc.

Generally, the minimum biometric data threshold may correspond to the silent or none notification level. In some embodiments, when biometric data of the user 101 falls within the minimum biometric data threshold the adaptive notification application 422 may prevent the client device 400 from producing audio, visual, and/or tactile notifications 450. In further embodiments, the adaptive notification application 422 may prevent the client device 400 from producing notifications 450 by communicating to the communication module 423 to terminate the network connection 104 of the client device 400 to the data network 105 as shown in FIGS. 8 and 10, such as by disabling one or more radios 406 of the client device 400, so that the client device 400 is unable to receive data used to form notifications 450. In other embodiments, the adaptive notification application 422 may prevent the client device 400 from producing notifications 450 by disabling one or more of the I/O interfaces 404 which are used to produce audible, tactile, and/or visual notifications 450, such as by placing the client device into silent mode.

Additionally, the one or more intermediate biometric data thresholds may correspond to the one or more intermediate notification levels. When biometric data of the user 101 falls within an intermediate biometric data threshold, the adaptive notification application 422 may enable the radios 406 of the client device 400, and therefore enable to client device 400 to receive data which may be used to produce notifications 450. An intermediate notification level may enable notifications 450 of a greater intensity than the silent or none notification level and a lesser intensity than the maximum notification level. Additionally, the client device 400 may be configured to produce notifications 450 at one or more notification levels, such as a first intermediate level, second intermediate level, third intermediate level, fourth intermediate level, and so on. In this manner, an intermediate biometric data threshold closer to the minimum biometric data threshold may correspond to an intermediate notification level which is a lesser level or intensity, and an intermediate biometric data threshold closer to the maximum biometric data threshold may correspond to an intermediate notification level which is a greater level or intensity. For example, a first intermediate biometric data threshold may comprise lower biometric data values than a second intermediate biometric data threshold. The first intermediate biometric data threshold may correspond to a first intermediate notification level that is less than, such as by being quieter, dimmer, or less haptically intense, than the second intermediate notification level that the second intermediate biometric data threshold corresponds to. When the biometric data of the user 101 falls within the second intermediate biometric data threshold, the adaptive notification application 422 may enable the client device 400 to produce notifications 450 of greater intensity than the notifications 450 produced by the client device 400 when the biometric data of the user 101 falls within the first intermediate biometric data threshold.

Generally, the maximum biometric data threshold may correspond to the maximum notification level. When biometric data of the user 101 falls within the maximum biometric data threshold, the adaptive notification application 422 may enable the radios 406 of the client device 400, and therefore enable to client device 400 to receive data which may be used to produce notifications 450. In some embodiments, when biometric data of the user 101 falls within the maximum biometric data threshold the adaptive notification application 422 may enable the client device 400 to produce audio, visual, and/or tactile notifications 450 of greater intensity than the intensity of the notifications 450 produced when the biometric data of the user 101 is in an intermediate biometric data threshold. In further embodiments, when biometric data of the user 101 falls within the maximum biometric data threshold the adaptive notification application 422 may enable the I/O interfaces 404 which are used to produce audible, tactile, and/or visual notifications 450 to produce notifications 450 at their maximum level.

The communication module 423 may be configured to govern electronic communication between one or more client devices 400 and servers 300. Data from client devices 400 and servers 300 may be received by the communication module 423 which may then electronically communicate the data to the biometric sensor application 421 and/or adaptive notification application 422. Likewise, data from the biometric sensor application 421 and/or adaptive notification application 422 may be received by the communication module 423 which may then electronically communicate the data to client devices 400 and servers 300. In some embodiments, the communication module 423 may govern the electronic communication 440 by initiating, maintaining, reestablishing, and terminating electronic communication 440 between the one or more client devices 400 and servers 300. In further embodiments, the communication module 423 may control the radio 406 of a client device 400 to send and receive data to and from one or more other client devices 400 and other servers 300 through a network connection 104 over a network 105. In further preferred embodiments, communication module 423 may prevent a client device 400 from producing a notification 450 by terminating the network connection 104 of the client device 400 to the data network 105.

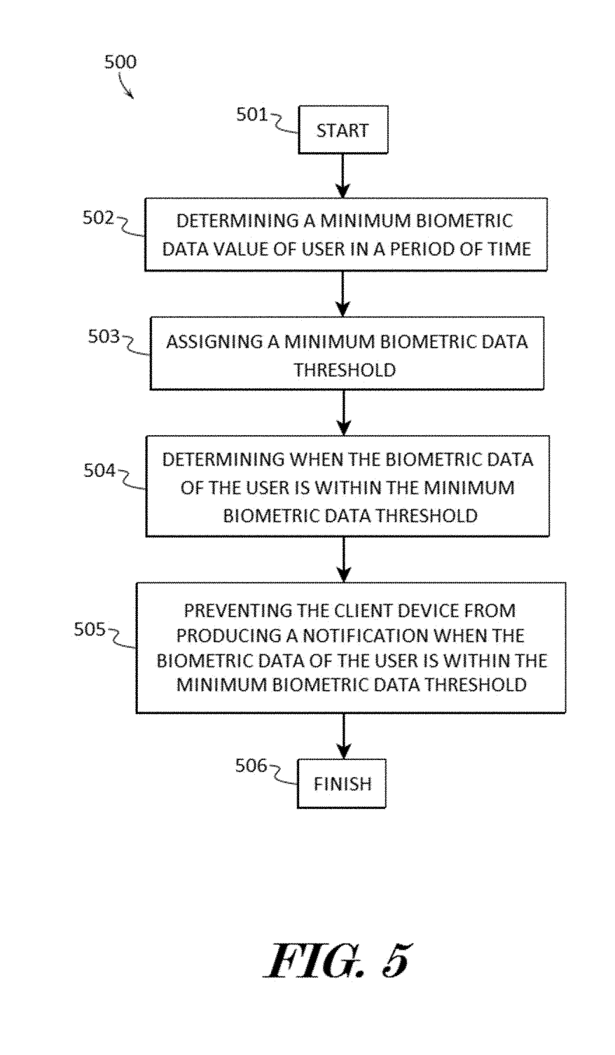

FIG. 5 illustrates a block diagram of an example of a method for preventing notifications 450 from a client device (“the method”) 500 according to various embodiments described herein. The method 500 may be used to provide adaptive notifications 450 from a client device 400 configured to access a data network 105 through a network connection 104 by preventing notifications 450 from a client device 400 using biometric data provided by a biometric sensor 415. One or more steps of the method may be performed by a biometric sensor application 421, an adaptive notification application 422, and/or a communication module 423.

In some embodiments, the method 500 may start 501 and a minimum biometric data value of user 100 in a period of time may be determined in step 502. The biometric data of the user 101 may include heart rate data, respiration rate data, perspiration rate data, and/or any other measurable type of biometric data. The biometric data may be recorded by a biometric sensor 415 and the biometric sensor application 421 may provide the data to the adaptive notification application 422. The adaptive notification application 422 may then determine the minimum biometric data value of user 100 in a period of time. The period of time can range anywhere from a few minutes to three or more days, but preferably 24 hours.

Next in step 503, a minimum biometric data threshold may be assigned by the adaptive notification application 422. A minimum biometric data threshold may describe a minimum range of biometric data values into which biometric data provided by the biometric sensor application 421 may fall. In some embodiments, a minimum biometric data threshold may be assigned by a range of biometric data which includes the minimum biometric data value of a user 101 recorded over a period of time. For example, the biometric data may comprise the heart rate of the user 101, and the minimum heart rate threshold may be assigned as between 100 percent and 110 percent of the minimum heart rate of the user 101 in a period of time. If the minimum biometric data value of user 100 in a period of time was 50 beats per minute, then the minimum heart rate threshold may be 50 to 55 beats per minute.

Step 504 may comprise determining when the biometric data of the user 101 is within the minimum biometric data threshold. The biometric data of the user 101 may be repeatedly recorded by the biometric sensor 415 and the biometric sensor application 421 may provide the data to the adaptive notification application 422 which may determine that the biometric data of the user 101 is within the minimum biometric data threshold. For example, biometric data received by the adaptive notification application 422 may comprise the respiration rate of the user 101 and a minimum biometric data threshold may be assigned as 30 or less breaths per minute. When the breathing rate of the user is 30 breaths or less per minute, the adaptive notification application 422 may determine that the breathing rate of the user 101 is within the minimum biometric data threshold.

Next in step 505, the client device 400 may be prevented from producing a notification when the biometric data of the user 101 is within the minimum biometric data threshold. In some embodiments, when biometric data of the user 101 falls within the minimum biometric data threshold the adaptive notification application 422 may prevent the client device 400 from producing audio, visual, and/or tactile notifications 450. In further embodiments, the adaptive notification application 422 may prevent the client device 400 from producing notifications 450 by communicating to the communication module 423 to terminate the network connection 104 of the client device 400 to the data network 105 as shown in FIGS. 8 and 10, such as by disabling one or more radios 406 of the client device 400, so that the client device 400 is unable to receive data used to form notifications 450. In this manner the client device 400 may be prevented from communicating to the data network 105 while allowing a wearable first client device 400A to communicate with a second client device 400B as shown in FIG. 8. In other embodiments, the adaptive notification application 422 may prevent the client device 400 from producing notifications 450 by disabling one or more of the I/O interfaces 404 which are used to produce audible, tactile, and/or visual notifications 450, such as by placing the client device into silent mode. Step 505 may continue until a desired time and/or be terminated by the user 101 after which the method 500 may finish 506.

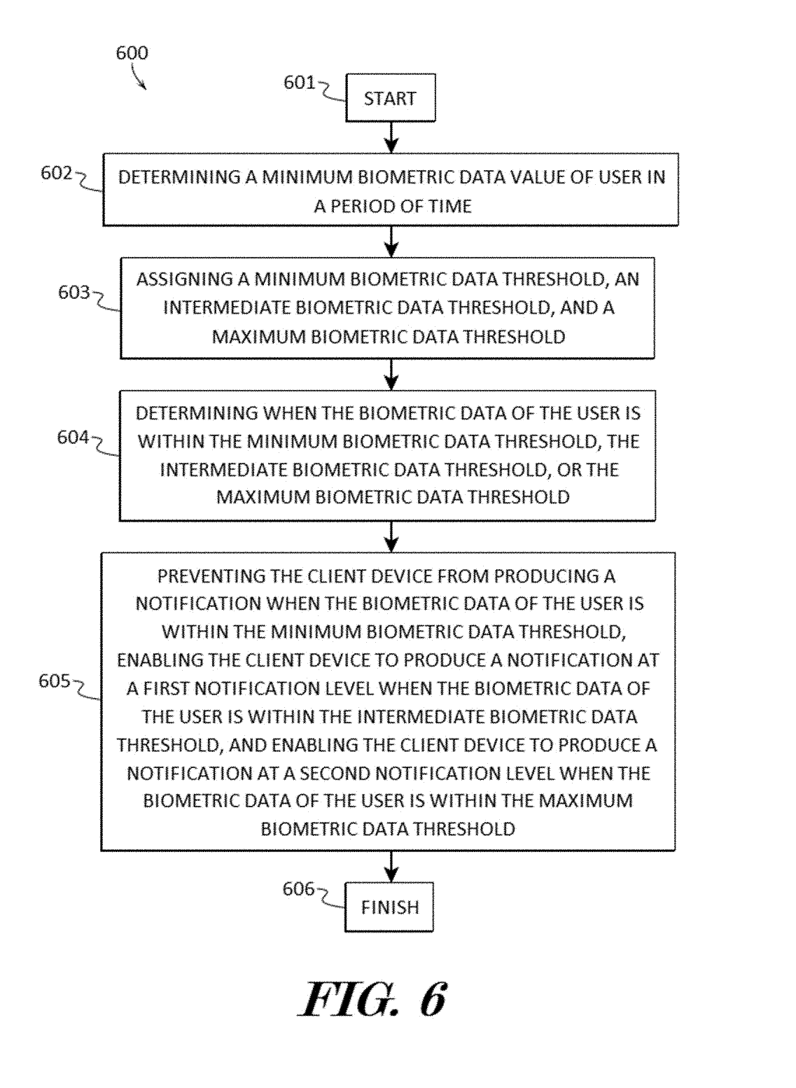

FIG. 6 shows a block diagram of an example of a method for providing adaptive notifications 450 from a client device (“the method”) 600 according to various embodiments described herein. The method 600 may be used to provide adaptive notifications 450 from a client device 400 configured to access a data network 105 through a network connection 104 by preventing notifications 450 and changing the intensity of notifications 450 from a client device 400 using biometric data provided by a biometric sensor 415. One or more steps of the method may be performed by a biometric sensor application 421, an adaptive notification application 422, and/or a communication module 423.

In some embodiments, the method 600 may start 601 and a minimum biometric data value of user 100 in a period of time may be determined in step 602. The biometric data of the user 101 may include heart rate data, respiration rate data, perspiration rate data, and/or any other measurable type of biometric data. The biometric data may be recorded by a biometric sensor 415 and the biometric sensor application 421 may provide the data to the adaptive notification application 422. The adaptive notification application 422 may then determine the minimum biometric data value of user 100 in a period of time. The period of time can range anywhere from a few minutes to three or more days, but preferably 24 hours.

In step 603, a minimum biometric data threshold, an intermediate biometric data threshold, and a maximum biometric data threshold may be assigned by the adaptive notification application 422. A minimum biometric data threshold may describe a minimum range of biometric data values into which biometric data provided by the biometric sensor application 421 may fall. In some embodiments, a minimum biometric data threshold may be assigned by a range of biometric data which includes the minimum biometric data value of a user 101 recorded over a period of time. An intermediate biometric data threshold may describe an intermediate range of biometric data values into which biometric data provided by the biometric sensor application 421 may fall. In some embodiments, an intermediate biometric data threshold may be assigned as a range of biometric data which preferably excludes the minimum and/or maximum biometric data values of a user recorded 101 over a period of time. A maximum biometric data threshold may describe a maximum range of biometric data values into which biometric data provided by the biometric sensor application 421 may fall. In some embodiments, a maximum biometric data threshold may be assigned as a range of biometric data based on the minimum and/or maximum biometric data value of a user 101 recorded over a period of time.

Each biometric data threshold may correspond to a notification level of a client device 400 of the user 101. A notification level may describe a level or intensity of notification which may be provided by a client device 400. Generally, the minimum biometric data threshold may correspond to the silent or none notification level, an intermediate biometric data threshold may correspond to an intermediate or a first notification level, and the maximum biometric data threshold may correspond to the maximum or a second notification level. An intermediate or first notification level may enable notifications 450 of a greater intensity than the silent or none notification level and a lesser intensity than the maximum or second notification level.

Step 604 may comprise determining when the biometric data of the user 101 is within the minimum biometric data threshold, the intermediate biometric data threshold, or the maximum biometric data threshold. The biometric data of the user 101 may be repeatedly recorded by the biometric sensor 415 and the biometric sensor application 421 may provide the data to the adaptive notification application 422 which may determine that the biometric data of the user 101 is within the minimum, intermediate, or maximum biometric data threshold. For example, biometric data received by the adaptive notification application 422 may comprise the heart rate of the user 101 and a minimum biometric data threshold may be assigned as 50 or less beats per minute, the intermediate biometric data threshold may be assigned as 51 to 90 beats per minute, and the maximum biometric data threshold may be assigned as 91 to 180 beats per minute. When the heart rate of the user is 50 beats or less per minute, the adaptive notification application 422 may determine that the heart rate of the user 101 is within the minimum biometric data threshold. When the heart rate of the user is 51 to 90 beats or less per minute, the adaptive notification application 422 may determine that the heart rate of the user 101 is within the intermediate biometric data threshold. When the heart rate of the user is 91 to 180 beats or less per minute, the adaptive notification application 422 may determine that the heart rate of the user 101 is within the maximum biometric data threshold.

Next in step 605, the client device 400 may be prevented from producing a notification when the biometric data of the user 101 is within the minimum biometric data threshold, enabling the client device 400 to produce a notification at a first notification level when the biometric data of the user 101 is within the intermediate biometric data threshold, and enabling the client device 400 to produce a notification at a second notification level when the biometric data of the user 101 is within the maximum biometric data threshold.

In some embodiments, when biometric data of the user 101 falls within the minimum biometric data threshold the adaptive notification application 422 may prevent the client device 400 from producing audio, visual, and/or tactile notifications 450. In further embodiments, the adaptive notification application 422 may prevent the client device 400 from producing notifications 450 by communicating to the communication module 423 to terminate the network connection 104 of the client device 400 to the data network 105 as shown in FIGS. 8 and 10, such as by disabling one or more radios 406 of the client device 400, so that the client device 400 is unable to receive data used to form notifications 450. In this manner the client device 400 may be prevented from communicating to the data network 105 while allowing a wearable first client device 400A to communicate with a second client device 400B as shown in FIG. 8. In other embodiments, the adaptive notification application 422 may prevent the client device 400 from producing notifications 450 by disabling one or more of the I/O interfaces 404 which are used to produce audible, tactile, and/or visual notifications 450, such as by placing the client device into silent mode. Step 605 may continue until a desired time and/or be terminated by the user 101 after which the method 600 may finish 606.

In some embodiments, when biometric data of the user 101 falls within the intermediate biometric data threshold the adaptive notification application 422 may enable the client device 400 to produce audio, visual, and/or tactile notifications 450 at a first notification level. In further embodiments, the adaptive notification application 422 may enable the client device 400 to produce notifications 450 by communicating to the communication module 423 to enable the network connection 104 of the client device 400 to the data network 105 as shown in FIGS. 1, 7, and 9, such as by enabling one or more radios 406 of the client device 400, so that the client device 400 is able to receive data used to form notifications 450. In other embodiments, the adaptive notification application 422 may enable the client device 400 to produce notifications 450 by enabling one or more of the I/O interfaces 404 which are used to produce audible, tactile, and/or visual notifications 450, to produce the notifications 450 at a first notification level.

In some embodiments, when biometric data of the user 101 falls within the maximum biometric data threshold the adaptive notification application 422 may enable the client device 400 to produce audio, visual, and/or tactile notifications 450 at a second notification level. In further embodiments, the second notification level may be greater than the first notification level. In further embodiments, the second notification level may be the maximum notification level of the client device 400. In further embodiments, the adaptive notification application 422 may enable the client device 400 to produce notifications 450 by communicating to the communication module 423 to enable the network connection 104 of the client device 400 to the data network 105 as shown in FIG. 8, such as by enabling one or more radios 406 of the client device 400, so that the client device 400 is able to receive data used to form notifications 450. In other embodiments, the adaptive notification application 422 may enable the client device 400 to produce notifications 450 by enabling one or more of the I/O interfaces 404 which are used to produce audible, tactile, and/or visual notifications 450, to produce the notifications 450 at a second notification level. Step 605 may continue until a desired time and/or be terminated by the user 101 after which the method 600 may finish 606.

Turning now to FIGS. 7 and 8, an example of a wearable first client device 400A which has a biometric sensor 415 and which is in electronic communication 440 with a second client device 400B that is configured to provide adaptive notifications 450 to the user 101 of the first 400A and second 400B client devices according to various embodiments is illustrated. In this example, the first client device 400A may include a biometric sensor 415 and may comprise a fitness tracker, smartwatch, and the like, while the second client device 400B may comprise a smartphone in communication with a network 105. The first client device 400A may be worn on the body of the user 101 to enable to biometric sensor 415 to record biometric data of the user 101. The first electronic device 400A may be in electronic communication 440 with the second client device 400B thereby enabling the biometric sensor 415 to be in wireless communication 440 with the second client device 400B. The biometric data may be electronically communicated 440 to the second client device 400B and used to provide adaptive notifications 450 from the second client device 400B based on the biometric data of the user 101 recorded by the first client device 400A as shown in FIG. 7. When biometric data of the user 101 falls within the minimum biometric data threshold the adaptive notification application 422 may prevent the client device 400 from producing audio, visual, and/or tactile notifications 450. In preferred embodiments, the adaptive notification application 422 may prevent the client device 400 from producing notifications 450 by communicating to the communication module 423 to terminate the network connection 104 of the client device 400 to the data network 105 as shown in FIG. 8, such as by disabling one or more radios 406 of the client device 400, so that the client device 400 is unable to receive data used to form notifications 450. In this manner the client device 400 may be prevented from communicating to the data network 105 while allowing a wearable first client device 400A to communicate with a second client device 400B as shown in FIG. 8.

Referring to FIGS. 9 and 10, an example of a wearable client device 400A which has an integral biometric sensor 415 and which is configured to provide adaptive notifications 450 to a user 101 is provided. In this example, the wearable client device 400A may include a biometric sensor 415 and may comprise a fitness tracker, smartwatch, and the like and the wearable client device 400A may be in communication with a network 105. Be wearing the client device 400A, the biometric sensor may be worn on the body of the user 101 to enable to biometric sensor 415 to record biometric data of the user 101. The biometric data recorded by the wearable client device 400A may be used to provide adaptive notifications 450 from the wearable client device 400A based on the biometric data of the user 101 recorded by the wearable client device 400A as shown in FIG. 9. When biometric data of the user 101 falls within the minimum biometric data threshold the adaptive notification application 422 may prevent the client device 400 from producing audio, visual, and/or tactile notifications 450. In preferred embodiments, the adaptive notification application 422 may prevent the client device 400 from producing notifications 450 by communicating to the communication module 423 to terminate the network connection 104 of the client device 400 to the data network 105 as shown in FIG. 10, such as by disabling one or more radios 406 of the client device 400, so that the client device 400 is unable to receive data used to form notifications 450.

It will be appreciated that some exemplary embodiments described herein may include one or more generic or specialized processors (or “processing devices”) such as microprocessors, digital signal processors, customized processors and field programmable gate arrays (FPGAs) and unique stored program instructions (including both software and firmware) that control the one or more processors to implement, in conjunction with certain non-processor circuits, some, most, or all of the functions of the methods and/or systems described herein. Alternatively, some or all functions may be implemented by a state machine that has no stored program instructions, or in one or more application specific integrated circuits (ASICs), in which each function or some combinations of certain of the functions are implemented as custom logic. Of course, a combination of the two approaches may be used. Moreover, some exemplary embodiments may be implemented as a computer-readable storage medium having computer readable code stored thereon for programming a computer, server, appliance, device, etc. each of which may include a processor to perform methods as described and claimed herein. Examples of such computer-readable storage mediums include, but are not limited to, a hard disk, an optical storage device, a magnetic storage device, a ROM (Read Only Memory), a PROM (Programmable Read Only Memory), an EPROM (Erasable Programmable Read Only Memory), an EEPROM (Electrically Erasable Programmable Read Only Memory), a Flash memory, and the like.

Embodiments of the subject matter and the functional operations described in this specification can be implemented in digital electronic circuitry, or in computer software, firmware, or hardware, including the structures disclosed in this specification and their structural equivalents, or in combinations of one or more of them. Embodiments of the subject matter described in this specification can be implemented as one or more computer program products, i.e., one or more modules of computer program instructions encoded on a tangible program carrier for execution by, or to control the operation of, data processing apparatus. The tangible program carrier can be a propagated signal or a computer readable medium. The propagated signal is an artificially generated signal, e.g., a machine generated electrical, optical, or electromagnetic signal that is generated to encode information for transmission to suitable receiver apparatus for execution by a computer. The computer readable medium can be a machine readable storage device, a machine readable storage substrate, a memory device, a composition of matter effecting a machine readable propagated signal, or a combination of one or more of them.

A computer program (also known as a program, software, software application, script, or code) can be written in any form of programming language, including compiled or interpreted languages, or declarative or procedural languages, and it can be deployed in any form, including as a standalone program or as a module, component, subroutine, or other unit suitable for use in a computing environment. A computer program does not necessarily correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program can be deployed to be executed on one computer or on multiple computers that are located at one site or distributed across multiple sites and interconnected by a communication network.

Additionally, the logic flows and structure block diagrams described in this patent document, which describe particular methods and/or corresponding acts in support of steps and corresponding functions in support of disclosed structural means, may also be utilized to implement corresponding software structures and algorithms, and equivalents thereof. The processes and logic flows described in this specification can be performed by one or more programmable processors executing one or more computer programs to perform functions by operating on input data and generating output.

Processors suitable for the execution of a computer program include, by way of example, both general and special purpose microprocessors, and any one or more processors of any kind of digital computer. Generally, a processor will receive instructions and data from a read only memory or a random access memory or both. The essential elements of a computer are a processor for performing instructions and one or more memory devices for storing instructions and data. Generally, a computer will also include, or be operatively coupled to receive data from or transfer data to, or both, one or more mass storage devices for storing data, e.g., magnetic, magneto optical disks, solid state drives, or optical disks. However, a computer need not have such devices.

Computer readable media suitable for storing computer program instructions and data include all forms of non volatile memory, media and memory devices, including by way of example semiconductor memory devices, e.g., EPROM, EEPROM, and flash memory devices; magnetic disks, e.g., internal hard disks or removable disks; magneto optical disks; and CD ROM and DVD ROM disks. The processor and the memory can be supplemented by, or incorporated in, special purpose logic circuitry.

To provide for interaction with a user, embodiments of the subject matter described in this specification can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input.

Embodiments of the subject matter described in this specification can be implemented in a computing system that includes a back end component, e.g., as a data server, or that includes a middleware component, e.g., an application server, or that includes a front end component, e.g., a client computer having a graphical user interface or a Web browser through which a user can interact with an implementation of the subject matter described is this specification, or any combination of one or more such back end, middleware, or front end components. The components of the system can be interconnected by any form or medium of digital data communication, e.g., a communication network. Examples of communication networks include a local area network (“LAN”) and a wide area network (“WAN”), e.g., the Internet.

The computing system can include clients and servers. A client and server are generally remote from each other and typically interact through a communication network or the cloud. The relationship of client and server arises by virtue of computer programs running on the respective computers and having a client server relationship to each other.

Further, many embodiments are described in terms of sequences of actions to be performed by, for example, elements of a computing device. It will be recognized that various actions described herein can be performed by specific circuits (e.g., application specific integrated circuits (ASICs)), by program instructions being executed by one or more processors, or by a combination of both. Additionally, these sequence of actions described herein can be considered to be embodied entirely within any form of computer readable storage medium having stored therein a corresponding set of computer instructions that upon execution would cause an associated processor to perform the functionality described herein. Thus, the various aspects of the invention may be embodied in a number of different forms, all of which have been contemplated to be within the scope of the claimed subject matter. In addition, for each of the embodiments described herein, the corresponding form of any such embodiments may be described herein as, for example, “logic configured to” perform the described action.

The computer system may also include a main memory, such as a random access memory (RAM) or other dynamic storage device (e.g., dynamic RAM (DRAM), static RAM (SRAM), and synchronous DRAM (SDRAM)), coupled to the bus for storing information and instructions to be executed by processor. In addition, the main memory may be used for storing temporary variables or other intermediate information during the execution of instructions by the processor. The computer system may further include a read only memory (ROM) or other static storage device (e.g., programmable ROM (PROM), erasable PROM (EPROM), and electrically erasable PROM (EEPROM)) coupled to the bus for storing static information and instructions for the processor.

The computer system may also include a disk controller coupled to the bus to control one or more storage devices for storing information and instructions, such as a magnetic hard disk, and a removable media drive (e.g., floppy disk drive, read-only compact disc drive, read/write compact disc drive, compact disc jukebox, tape drive, and removable magneto-optical drive). The storage devices may be added to the computer system using an appropriate device interface (e.g., small computer system interface (SCSI), integrated device electronics (IDE), enhanced-IDE (E-IDE), direct memory access (DMA), or ultra-DMA).

The computer system may also include special purpose logic devices (e.g., application specific integrated circuits (ASICs)) or configurable logic devices (e.g., simple programmable logic devices (SPLDs), complex programmable logic devices (CPLDs), and field programmable gate arrays (FPGAs)).

The computer system may also include a display controller coupled to the bus to control a display, such as a cathode ray tube (CRT), liquid crystal display (LCD) or any other type of display, for displaying information to a computer user. The computer system may also include input devices, such as a keyboard and a pointing device, for interacting with a computer user and providing information to the processor. Additionally, a touch screen could be employed in conjunction with display. The pointing device, for example, may be a mouse, a trackball, or a pointing stick for communicating direction information and command selections to the processor and for controlling cursor movement on the display. In addition, a printer may provide printed listings of data stored and/or generated by the computer system.

The computer system performs a portion or all of the processing steps of the invention in response to the processor executing one or more sequences of one or more instructions contained in a memory, such as the main memory. Such instructions may be read into the main memory from another computer readable medium, such as a hard disk or a removable media drive. One or more processors in a multi-processing arrangement may also be employed to execute the sequences of instructions contained in main memory. In alternative embodiments, hard-wired circuitry may be used in place of or in combination with software instructions. Thus, embodiments are not limited to any specific combination of hardware circuitry and software.

As stated above, the computer system includes at least one computer readable medium or memory for holding instructions programmed according to the teachings of the invention and for containing data structures, tables, records, or other data described herein. Examples of computer readable media are compact discs, hard disks, floppy disks, tape, magneto-optical disks, PROMs (EPROM, EEPROM, flash EPROM), DRAM, SRAM, SDRAM, or any other magnetic medium, compact discs (e.g., CD-ROM), or any other optical medium, punch cards, paper tape, or other physical medium with patterns of holes, a carrier wave (described below), or any other medium from which a computer can read.

Stored on any one or on a combination of computer readable media, the present invention includes software for controlling the computer system, for driving a device or devices for implementing the invention, and for enabling the computer system to interact with a human user. Such software may include, but is not limited to, device drivers, operating systems, development tools, and applications software. Such computer readable media further includes the computer program product of the present invention for performing all or a portion (if processing is distributed) of the processing performed in implementing the invention.

The computer code or software code of the present invention may be any interpretable or executable code mechanism, including but not limited to scripts, interpretable programs, dynamic link libraries (DLLs), Java classes, and complete executable programs. Moreover, parts of the processing of the present invention may be distributed for better performance, reliability, and/or cost.

Various forms of computer readable media may be involved in carrying out one or more sequences of one or more instructions to processor for execution. For example, the instructions may initially be carried on a magnetic disk of a remote computer. The remote computer can load the instructions for implementing all or a portion of the present invention remotely into a dynamic memory and send the instructions over the air (e.g. through a wireless cellular network or Wifi network). A modem local to the computer system may receive the data over the air and use an infrared transmitter to convert the data to an infrared signal. An infrared detector coupled to the bus can receive the data carried in the infrared signal and place the data on the bus. The bus carries the data to the main memory, from which the processor retrieves and executes the instructions. The instructions received by the main memory may optionally be stored on storage device either before or after execution by processor.

The computer system also includes a communication interface coupled to the bus. The communication interface provides a two-way data communication coupling to a network link that is connected to, for example, a local area network (LAN), or to another communications network such as the Internet. For example, the communication interface may be a network interface card to attach to any packet switched LAN. As another example, the communication interface may be an asymmetrical digital subscriber line (ADSL) card, an integrated services digital network (ISDN) card or a modem to provide a data communication connection to a corresponding type of communications line. Wireless links may also be implemented. In any such implementation, the communication interface sends and receives electrical, electromagnetic or optical signals that carry digital data streams representing various types of information.

The network link typically provides data communication to the cloud through one or more networks to other data devices. For example, the network link may provide a connection to another computer or remotely located presentation device through a local network (e.g., a LAN) or through equipment operated by a service provider, which provides communication services through a communications network. In preferred embodiments, the local network and the communications network preferably use electrical, electromagnetic, or optical signals that carry digital data streams. The signals through the various networks and the signals on the network link and through the communication interface, which carry the digital data to and from the computer system, are exemplary forms of carrier waves transporting the information. The computer system can transmit and receive data, including program code, through the network(s) and, the network link and the communication interface. Moreover, the network link may provide a connection through a LAN to a client device such as a personal digital assistant (PDA), laptop computer, or cellular telephone. The LAN communications network and the other communications networks such as cellular wireless and wifi networks may use electrical, electromagnetic or optical signals that carry digital data streams. The processor system can transmit notifications 450 and receive data, including program code, through the network(s), the network link and the communication interface.

Although the present invention has been illustrated and described herein with reference to preferred embodiments and specific examples thereof, it will be readily apparent to those of ordinary skill in the art that other embodiments and examples may perform similar functions and/or achieve like results. All such equivalent embodiments and examples are within the spirit and scope of the present invention, are contemplated thereby, and are intended to be covered by the following claims.

What is claimed is:

1. A method for providing adaptive notifications from a client device of a user configured to access a data network through a network connection, the method comprising the steps of:
determining a minimum value of biometric data of user in a period of time with a biometric sensor;
assigning a minimum biometric data threshold with a processor of the client device;
determining when the biometric data of the user is within the minimum biometric data threshold with a processor of the client device; and
preventing the client device from producing a notification when the biometric data of the user is within the minimum biometric data threshold with the processor of the client device.

2. The method of claim 1, wherein the client device is prevented from producing a notification by terminating the network connection of the client device to the data network.

3. The method of claim 1, wherein the client device is prevented from producing a notification by preventing the client device from producing an audible notification.

4. The method of claim 1, wherein the client device is prevented from producing a notification by preventing the client device from producing a tactile notification.

5. The method of claim 1, wherein the client device is prevented from producing a notification by preventing the client device from producing a visual notification.

6. The method of claim 1, wherein the biometric sensor is worn on the body of the user.

7. The method of claim 1, wherein the biometric sensor is in wireless communication with the client device.

8. The method of claim 1, wherein the biometric data of the user is selected from the group consisting essentially of heart rate, respiration rate, and perspiration rate.

9. The method of claim 1, wherein the biometric data is the heart rate of the user, and wherein the minimum heart rate threshold is between 100 percent and 110 percent of the minimum heart rate of the user in a period of time.

10. A method for providing adaptive notifications from a client device of a user configured to access a data network through a network connection, the method comprising the steps of:
determining a minimum value of biometric data of user in a period of time with a biometric sensor;
assigning a minimum biometric data threshold, an intermediate biometric data threshold, and a maximum biometric data threshold with a processor of the client device;
determining when the biometric data of the user is within the minimum biometric data threshold, within the intermediate biometric data threshold, or within the maximum biometric data threshold with a processor of the client device; and
preventing the client device from producing a notification when the biometric data of the user is within the minimum biometric data threshold, enabling the client device to produce a notification at a first notification level when the biometric data of the user is within the intermediate biometric data threshold, and enabling the client device to produce a notification at a second notification level when the biometric data of the user is within the maximum biometric data threshold with a processor of the client device.

11. The method of claim 10, wherein the client device is prevented from producing a notification by terminating the network connection of the client device to the data network.

12. The method of claim 10, wherein the client device is prevented from producing a notification by preventing the client device from producing an audible notification.

13. The method of claim 10, wherein the client device is prevented from producing a notification by preventing the client device from producing a tactile notification.

14. The method of claim 10, wherein the client device is prevented from producing a notification by preventing the client device from producing a visual notification.

15. The method of claim 10, wherein the biometric sensor is worn on the body of the user.

16. The method of claim 10, wherein the biometric sensor is in wireless communication with the client device.

17. The method of claim 10, wherein the biometric data of the user is selected from the group consisting essentially of heart rate, respiration rate, and perspiration rate.

18. The method of claim 10, wherein the biometric data is the heart rate of the user, and wherein the minimum heart rate threshold is between 100 percent and 110 percent of the minimum heart rate of the user in a period of time.

19. The method of claim 10, wherein the second notification level is greater than the first notification level.

20. The method of claim 10, wherein the second notification level is the maximum notification level of the client device.
